(19) United States
(12) Patent Application Publication
(10) Pub. No.: US 2015/0207233 A1
(43) Pub. Date: Jul. 23, 2015

(54) DIELECTRIC RESONATOR ANTENNA

(71) Applicant: Electronics and Telecommunications Research Institute, Daejeon (KR)

(72) Inventors: Dong Young KIM, Daejeon (KR); Jong Won LIM, Daejeon (KR); Cheon Soo KIM, Daejeon (KR)

(73) Assignee: Electronics and Telecommunications Research Institute, Daejeon (KR)

(21) Appl. No.: 14/337,907

(22) Filed: Jul. 22, 2014

(30) Foreign Application Priority Data
Jan. 22, 2014 (KR) 10-2014-0007748

(51) Int. Cl. H01Q 9/04; H01Q 1/50; H01Q 1/48

(52) U.S. Cl. CPC H01Q 9/0485; H01Q 1/48; H01Q 1/50

(57) ABSTRACT

Disclosed is a dielectric resonator antenna. The dielectric resonator antenna includes: a dielectric resonator; an antenna layer formed inside the dielectric resonator, and including a plurality of vias positioned at a surrounding area of the dielectric resonator; a metal pattern forming an opened surface in an upper portion of the antenna layer; a dielectric layer configured to cover the metal pattern on the dielectric resonator; an internal ground pattern including a coupling aperture for inputting a signal into the dielectric resonator under the dielectric resonator; and a feeding layer including a strip transmission line for transmitting a signal to the dielectric resonator, and positioned under the antenna layer.

### CROSS-REFERENCE TO RELATED APPLICATION

This application is based on and claims priority from Korean Patent Application No. 10-2014-0007748, filed on Jan. 22, 2014, with the Korean Intellectual Property Office, the disclosure of which is incorporated herein in its entirety by reference.

### BACKGROUND

1. Field

The present invention relates to an antenna system, and more particularly, to a substrate buried dielectric resonator antenna based on Low Temperature Co-Fired Ceramic (LTCC), which can decrease manufacturing cost.

2. Discussion of Related Art

A frequency in a millimeter wave band has an excellent straightforward propagation, and a broadband characteristic, compared to a frequency in a microwave band, thereby attracting attentions for application to a radar or communication service. Particularly, since the millimeter wave band has a short wavelength, an antenna is easily miniaturized, thereby innovatively decreasing a size of a system. Broadband communication using a band of 60 GHz and a vehicular radar using a band of 77 GHz have particularly attracted attentions as services using the millimeter wave band, are currently released as products through commercialization.

In order to configure the system using the millimeter wave band, research on implementation of a system in a form of a System In Packaging (SIP) capable of achieving miniaturization of a product and decreasing cost has been actively conducted. Technologies, such as a Low Temperature Co-fired Ceramic (hereinafter, referred to as “LTCC”) process and a Liquid Crystal Polymer (hereinafter, referred to as “LCP”) process, are considered as the method of implementing the SIP. The technologies, such as the LTCC process and the LCP process, may minimize and lower a price of a module by using a multilayer substrate.

Particularly, when the LTCC process is used, an antenna-integrated module may be implemented in a form of an Antenna In Package (AIP) by integrating the antenna with a Front End Module (FEM) and burying the antenna. In general, a patch antenna is widely used as an antenna structure suitable to the configuration of the AIP. However, when the patch antenna operated in a millimeter wave frequency band, particularly, a high frequency band of about 60 GHz or higher, is manufactured, there is a problem in that an antenna characteristic deteriorates due to leakage of a signal by generation of a surface wave propagation throughout a surface of a dielectric substrate.

This leakage of the signal degrades radiation efficiency of an antenna, and antenna gain also deceases due to this leakage. As a thickness of a substrate used increases, and as a dielectric constant of the substrate increases, the leakage of the signal is increased, and antenna gain is decreased. Accordingly, the patch antenna based on the LTCC process requires a complex structure, such as introduction of an air cavity in order to decrease the effective dielectric constant of a substrate, or insertion of an electro-magnetic band gap structure, for suppressing propagation of the surface wave. In the meantime, a process of forming the air cavity, which digs out an inner side of the substrate in the LTCC process, degrades a yield of a product, so that the process is not appropriate to mass production.

In addition to the patch antenna, the dielectric resonator antenna is also suitable for the AIP structure. In the antenna using the dielectric resonator, the dielectric resonator serving as the antenna is surrounded by a metal, so that the generation of the surface wave is structurally suppressed, thereby achieving a good antenna characteristic.

The dielectric resonator antenna using the LTCC process requires top metal surface with open aperture which radiates signal to the air. In the LTCC process, a metal pattern of each layer is printed by screen printing using a silver (Ag) paste, and these layers are stacked and laminated, and then finally co-fired. In this case, a silver (Ag) electrode exposed on the surface is reacted with external oxygen to be easily oxidized, so that a gold plating process is additionally performed to suppress oxidization.

As described above, the existing dielectric resonator antenna using the LTCC requires an expensive gold plating process due to the metal exposed to the outside, so that there is a problem in that a manufacturing process is considerably increased.

### SUMMARY

The present invention has been made in an effort to provide a dielectric resonator antenna capable of decreasing antenna manufacturing cost. Further, the present invention has been made in an effort to provide a dielectric resonator antenna in which a metal pattern is buried inside a substrate in an antenna with multi layered substrate.

An exemplary embodiment of the present invention provides a dielectric resonator antenna includes: a dielectric resonator; an antenna layer which the dielectric resonator formed inside including a plurality of vias positioned at a surrounding area of the dielectric resonator; a metal pattern forming an opened surface in an upper portion of the antenna layer; a dielectric layer configured to cover the metal pattern on the dielectric resonator; an internal ground pattern including a coupling aperture for inputting a signal into the dielectric resonator under the dielectric resonator; and a feeding layer including a strip transmission line for transmitting a signal to the dielectric resonator, and positioned under the antenna layer.

In the present exemplary embodiment, the dielectric resonator antenna may further include an external ground surface positioned under the feeding layer.

In the present exemplary embodiment, the plurality of vias may be formed inside the antenna layer, and forms a metallic fence of the dielectric resonator so as to suppress leakage of a signal.

In the present exemplary embodiment, the plurality of vias may be disposed by setting an interval between the plurality of vias to have a value corresponding to ¼ of a frequency wavelength of the dielectric resonator antenna.

In the present exemplary embodiment, a bandwidth of the dielectric resonator antenna may be expanded by adjusting a size of a coupling aperture.

In the present exemplary embodiment, the feeding layer may include a plurality of vias positioned at a surrounding area of the strip transmission line.

In the present exemplary embodiment, the feeding layer may include two layers, and the strip transmission line may be positioned between the two layers.

In the present exemplary embodiment, the internal ground pattern and the external ground surface may be connected through the plurality of vias positioned at a surrounding area of the strip transmission line.

Another exemplary embodiment of the present invention provides a dielectric resonator antenna includes: a plurality of layers; a dielectric resonator positioned inside the plurality of layers; a plurality of vias positioned inside the plurality of layers, and positioned at a surrounding area of the dielectric resonator antenna; a metal pattern positioned on the dielectric resonator, and buried inside the plurality of layers; and an internal ground pattern positioned under the dielectric resonator, and positioned between the layers, in which the metal pattern and the internal ground surface are connected with each other through the plurality of vias.

In the present exemplary embodiment, the plurality of vias may form a metallic fence of the dielectric resonator so as to suppress leakage of a signal.

In the present exemplary embodiment, the plurality of vias may be disposed by setting an interval between the plurality of vias to have a value corresponding to ¼ of a frequency wavelength of the dielectric resonator antenna.

In the present exemplary embodiment, the internal ground pattern may include a coupling aperture for inputting a signal into the dielectric resonator, and a bandwidth of the dielectric resonator antenna may be expanded by adjusting a size of the coupling aperture.

In the present exemplary embodiment, the plurality of layers may include: an antenna layer on which the dielectric resonator and the plurality of vias are formed; a dielectric layer positioned on the antenna layer; and a feeding layer positioned under the antenna layer to transmit a signal to the dielectric resonator.

In the present exemplary embodiment, the dielectric resonator antenna may further include an external ground surface positioned under the feeding layer.

In the present exemplary embodiment, the feeding layer may include: a strip transmission line configured to transmit a signal to the dielectric resonator; and a plurality of vias positioned at a surrounding area of the strip transmission line, and the plurality of vias connects the internal ground pattern and the external ground surface.

According to the dielectric resonator antenna of the present invention, the dielectric resonator is buried inside the substrates to remove a metal pattern exposed to the outside, thereby removing an expensive gold plating process for protecting the metal pattern and thus decreasing process cost.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a diagram illustrating a structure of a dielectric resonator antenna according to an exemplary embodiment of the present invention;

FIG. 2 is a diagram illustrating a cross-section of the dielectric resonator antenna according to the exemplary embodiment of the present invention;

FIG. 3 is a diagram illustrating a strip transmission line and a coupling aperture according to the exemplary embodiment of the present invention;

FIG. 4 is a diagram illustrating an antenna using a dielectric resonator for describing a dielectric resonator antenna according to an exemplary embodiment of the present invention;

FIG. 5 is a graph illustrating an example of a reflection characteristic of the dielectric resonator antenna of FIG. 4;

FIG. 6 is a graph illustrating an example of a gain of the dielectric resonator antenna of FIG. 4;

FIG. 7 is a graph illustrating an example of a reflection characteristic of the dielectric resonator antenna of FIG. 1; and

FIG. 8 is a graph illustrating an example of a gain of the dielectric resonator antenna of FIG. 1.

### DETAILED DESCRIPTION

Hereinafter, an embodiment of the present invention will be described with reference to the accompanying drawings in detail. However, the present invention is not limited to an embodiment disclosed below and may be implemented in various forms and the scope of the present invention is not limited to the following embodiments. Rather, the embodiment is provided to more sincerely and fully disclose the present invention and to completely transfer the spirit of the present invention to those skilled in the art to which the present invention pertains, and the scope of the present invention should be understood by the claims of the present invention.

The present invention provides a dielectric resonator antenna, in which a metal pattern is buried inside substrates in an antenna formed of a plurality of layers to decrease a size of a module. To this end, the present invention will be described based on an antenna, which is implemented by using a multilayer structure Low Temperature Co-fired Ceramic (LTCC) technology, as an example. Further, the dielectric resonator antenna of the present invention is applied to an Antenna In Package (AIP) operated in a high frequency wave band equal to or higher than a millimeter wave frequency band (particularly, 60 GHz). However, in addition to the millimeter wave frequency band, the dielectric resonator antenna of the present invention may also be expanded and used even in another frequency band.

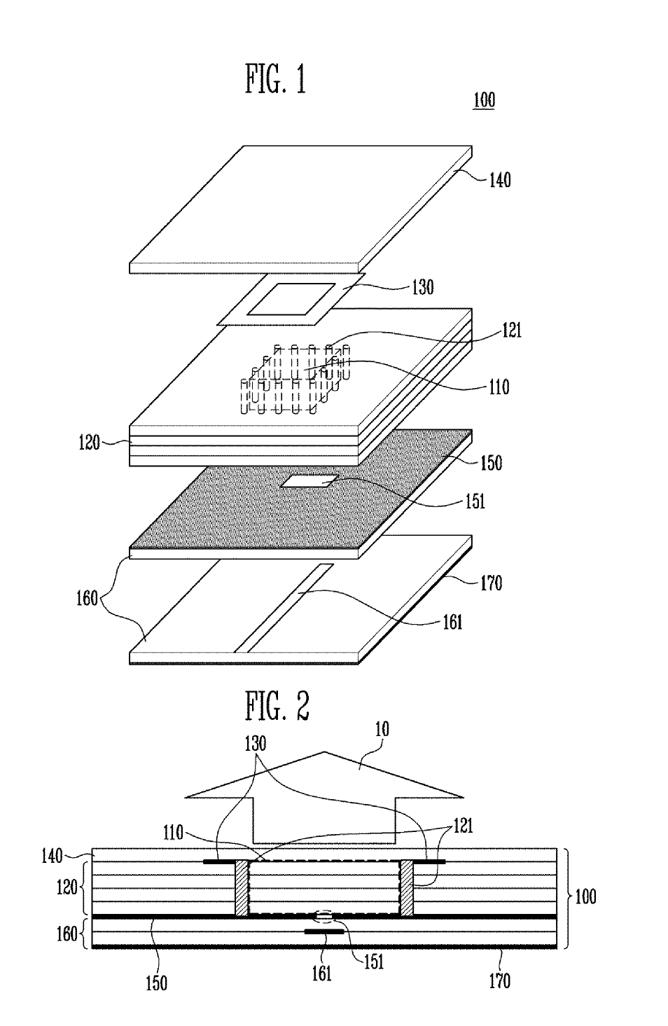

FIG. 1 is a diagram illustrating a structure of a dielectric resonator antenna according to an exemplary embodiment of the present invention.

Referring to FIG. 1, a dielectric resonator antenna 100 includes a dielectric resonator 110, an antenna layer 120, a metal pattern 130, a dielectric layer 140, an internal ground pattern 150, a feeding layer 160, and an external ground surface 170.

The dielectric resonator 110 is buried inside the antenna layer 120. The dielectric resonator 110 may have a thickness and a size according to resonance in a designed frequency band of the dielectric resonator 110.

The antenna substrate 10 may be formed of a plurality of layers in which a plurality of substrates is stacked, and includes the dielectric resonator 110 therein. The antenna layer 120 includes a plurality of vias 121 surrounding the dielectric resonator 110. Here, the plurality of vias 121 may be formed of a metal. Further, the plurality of vias 121 acts as a metallic fence through a connection of the metal pattern 130 and the internal ground surface 150, thereby preventing signal leakage through a dielectric layers, and configuring the dielectric resonator 110.

The metal pattern 130 is positioned on the dielectric resonator 110. The metal pattern 130 has an open aperture to radiating signal to the air.

The dielectric layer 140 is positioned on the metal pattern 130 to protect the metal pattern 130. For example, the dielectric layer 140 may be formed of one layer.

The internal ground pattern 150 is positioned under the dielectric resonator 110. The internal ground pattern 150 is a metal pattern, and has a ground function of the antenna. The internal ground pattern 150 is connected to the metal pattern 130 through the plurality of vias 121. The plurality of vias 121 is disposed in a form surrounding a surrounding area of the dielectric resonator 110. The internal ground pattern 150 includes a coupling aperture 151 for inputting a signal into the dielectric resonator 110. Here, the coupling aperture 151 may be positioned at a lower end of the dielectric resonator 110, and is provided for inputting an antenna signal.

The feeding layer 160 is positioned under the internal ground pattern 150. For example, the feeding layer 160 may be formed of two layers, and a strip transmission line 161 is positioned between the layers configuring the feeding layer 160. The strip transmission line 161 is used for feeding a signal. Part of the strip transmission line 161 may be positioned at a lower end of a region formed by the coupling aperture 151.

The external ground surface 170 is positioned at a lower end of the feeding layer 160. The external ground surface 170 is a metal surface, and has a ground function.

The dielectric resonator antenna 100 employs the LTCC technology having a multilayer structure. For example, the dielectric resonator antenna 100 may be operated in a high frequency band of a millimetric frequency band, particularly, 60 GHz or higher.

As described above, the dielectric layer 150 is positioned on the topmost surface of the antenna, so that the dielectric resonator antenna 100 suggested in the present invention is formed of only a dielectric material without exposure of the metal. To this end, the metal surface exposed to the outside of the substrate is removed, so that the dielectric resonator antenna 100 does not require a gold plating process for preventing oxidation of the metal outside the substrate in the LTCC process, thereby decreasing process cost.

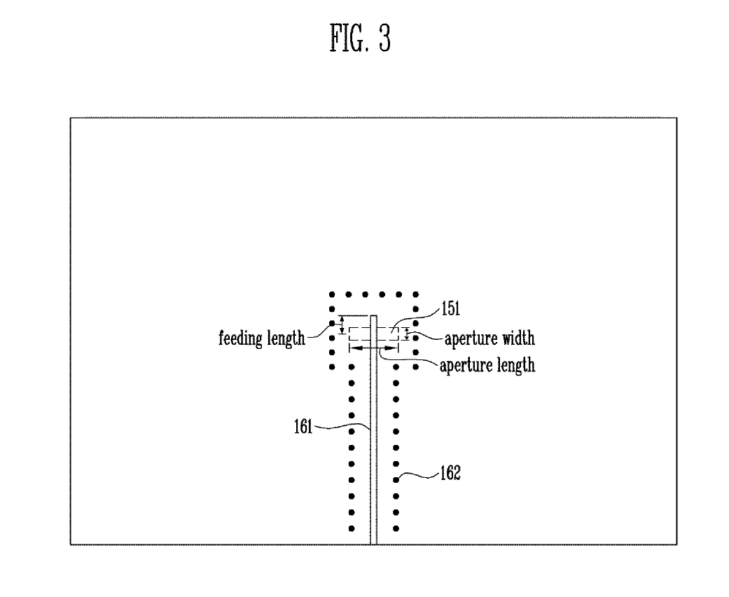

FIG. 2 is a diagram illustrating a cross-section of the dielectric resonator antenna according to the exemplary embodiment of the present invention.

Referring to FIG. 2, the dielectric resonator antenna 100 includes the dielectric resonator 110, the antenna layer 120, the metal pattern 130, the dielectric layer 140, the internal ground pattern 150, the feeding layer 160, and the external ground surface 170. Here, FIG. 2 illustrates a cross-sectional view of the dielectric resonator antenna 100 illustrated in FIG. 1.

The dielectric resonator 110 is located inside the antenna layer 120. A signal is radiated 10 through an upper portion of the dielectric resonator 110.

The antenna layer 120 includes the plurality of vias 121. Here, a case where the antenna layer 120 includes four substrates is illustrated as an example. In this case, the plurality of vias 121 is positioned at a lateral surface of the dielectric resonator 110.

The metal pattern 130 is positioned on the antenna layer 120, and is connected to upper ends of the vias 121 around the dielectric resonator 110.

The dielectric layer 140 is positioned on the metal pattern 130.

The internal ground pattern 150 is positioned at a lower end of the antenna layer 120. The coupling aperture 151 for transmitting the signal to the antenna is formed in the internal ground pattern 150. For example, the internal ground pattern 150 may be formed of a metal layer using a silver (Ag) paste.

In this case, the internal ground pattern 150 and the metal pattern 130 are electrically connected by using the metallic vias 121.

The feeding layer 160 includes the strip transmission line 161 therein. Here, a case where the feeding layer 160 includes two layers is illustrated as an example. In this case, the strip transmission line 161 may be positioned between the two layers, and a part of the strip transmission line 161 may be positioned at a lower end of the region formed by the coupling aperture 151.

The external ground surface 170 is positioned at a lower end of the feeding layer 160.

For example, the dielectric resonator antenna 100 suggested in the present invention is formed of an LTCC multilayer substrate having a dielectric constant of 6.0, and a dielectric loss tangent of 0.0035. In this case, the dielectric resonator antenna 100 is formed of layers including the seven layers (four antenna layers 120, one dielectric layer 140, and two feeding layers 160).

The dielectric resonator 110 may be formed inside the antenna layer 120, and the antenna layer 120 is formed of four layers. The thickness of each layer is 0.1 mm, and the dielectric resonator 110 has a thickness of 0.4 mm.

The dielectric resonator 110 is surrounded by the vias. In this case, when the vias are disposed by decreasing an interval between the vias to have a value equal to or lower than ¼ of a wavelength in a determined frequency, the vias acts as a metallic wall, thereby preventing a leakage of a signal.

FIG. 3 is a diagram illustrating the strip transmission line and the coupling aperture according to the exemplary embodiment of the present invention.

FIG. 3 illustrates the strip transmission line 161 positioned on the feeding layer 160. The coupling aperture 151 positioned on the strip transmission line 161 is also illustrated.

In this case, the feeding layer 160 may include the plurality of vias for preventing a signal leakage to the surrounding area of the strip transmission line 161. The plurality of vias 162 connects the internal ground pattern 150 positioned at the upper side and the external ground surface 170 positioned at the lower side. In this case, the plurality of vias 162 is disposed in a form surrounding the surrounding area of the strip transmission line 161 and the coupling aperture 151.

For the coupling of the dielectric resonator 110 and feed line at the designed frequency, a size, that is, a length and a width, of the coupling aperture 151 may be changed. Further, a distance from a center point of the coupling aperture 151 to an end portion of the strip transmission line entering into the feeding layer 160, that is, a feeding length, may also be changed for the coupling with the dielectric resonator 110.

Accordingly, the bandwidth of the dielectric resonator antenna 100 may be expanded by the coupling through the control of the aperture length, the aperture width, and the feed length.

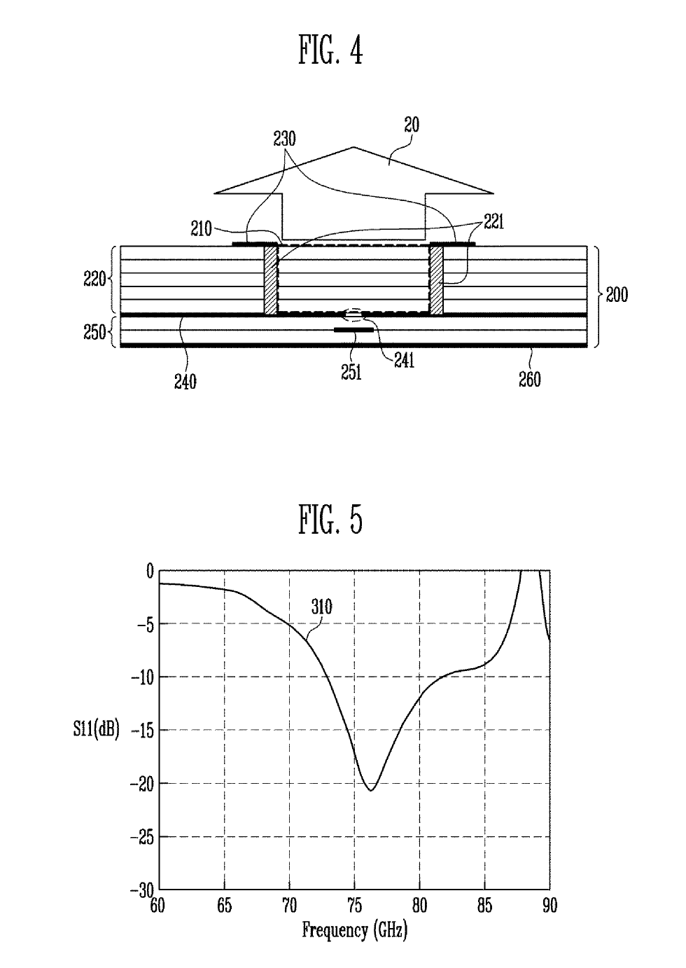

FIG. 4 is a diagram illustrating an antenna using a dielectric resonator for describing a dielectric resonator antenna according to an exemplary embodiment of the present invention.

Referring to FIG. 4, a dielectric resonator antenna 200 includes a dielectric resonator 210, an antenna layer 220, a metal pattern 230, an internal ground pattern 240, a feeding layer 250, and an external ground surface 260.

The dielectric resonator antenna 200 illustrated in FIG. 4 generally has a similar structure to that of the dielectric resonator antenna 100 illustrated in FIG. 2. Here, in order to confirm performance of the dielectric resonator antenna 100 illustrated in FIG. 2, the dielectric resonator antenna 200 has a structure exposing the metal pattern 230 in the structure of FIG. 2.

In the dielectric resonator antenna 200, the metal pattern 230 is exposed on an upper portion of the substrate, so that an expensive gold plating process is demanded.

Accordingly, the remaining general configurations, except for a difference that the dielectric layer is not present on the metal pattern 230, will be referred to the description of FIG. 2 or FIG. 1.

Here, the dielectric resonator antenna 200 is formed of seven layers (five antenna layers 220 and two feeding layer 250).

In FIG. 4, for a comparison with FIG. 2 (or FIG. 1), the dielectric resonator 210 is designed to be resonated at a frequency of about 77 GHz.

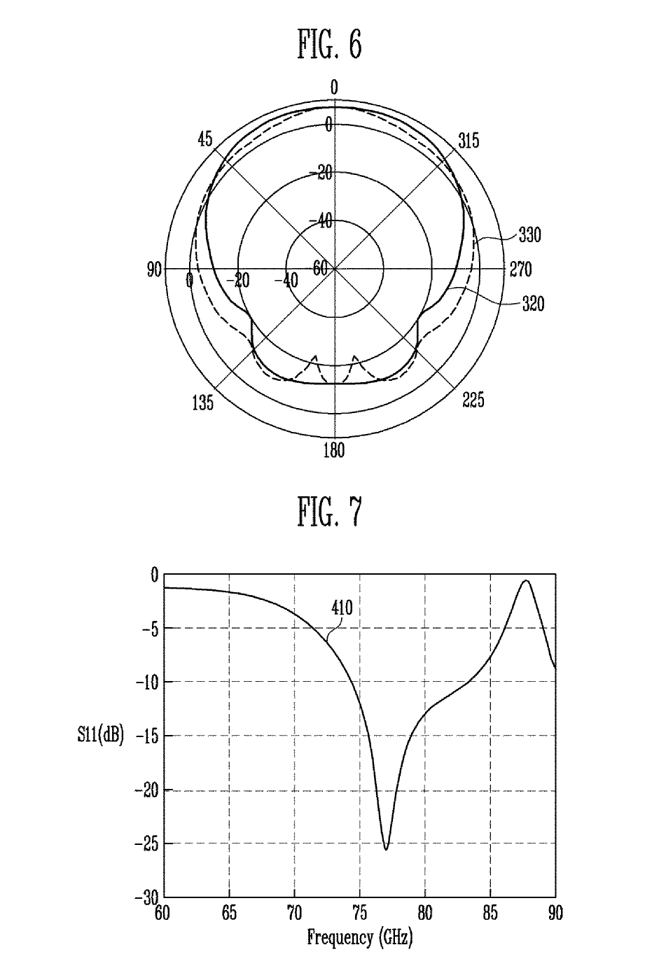

FIG. 5 is a graph illustrating an example of a reflection characteristic of the dielectric resonator antenna of FIG. 4.

Referring to FIG. 5, a horizontal axis of the graph indicates a frequency GHz, and a vertical axis indicates an S parameter (S11(dB)).

In this case, FIG. 5 illustrates a reflection characteristic 310 of the dielectric resonator antenna 200 simulated using a High Frequency Structural Simulator (HFSS).

The dielectric resonator antenna 200 shows wide bandwidth of 8.8 GHz, which is between 72.9 GHz and 81.7 GHz.

FIG. 6 is a graph illustrating an example of a gain of the dielectric resonator antenna of FIG. 4.

FIG. 6 illustrates radiation patterns along a electric field (E-field) direction 320 and along a magnetic field (H-field) direction 330. Accordingly, a gain of the dielectric resonator antenna 200 at 77 GHz is 7.4 dBi, so that the dielectric resonator antenna 200 has an excellent characteristic compared to a general patch antenna.

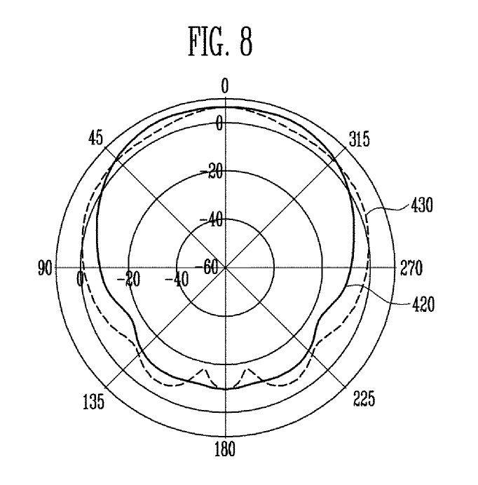

FIG. 7 is a graph illustrating an example of a reflection characteristic of the dielectric resonator antenna of FIG. 1.

Referring to FIG. 7, a horizontal axis of the graph indicates a frequency GHz, and a vertical axis indicates an S parameter (S11(dB)).

In this case, FIG. 7 illustrates a reflection characteristic 410 of the dielectric resonator antenna 100 measured by using the HFSS.

The dielectric resonator antenna 100 shows wide bandwidth of 8.9 GHz, which is between 74.7 GHz and 83.3 GHZ.

FIG. 8 is a graph illustrating an example of a gain of the dielectric resonator antenna illustrated in FIG. 1.

FIG. 8 illustrates radiation patterns along a electric field (E-field) direction 420 and along a magnetic field (H-field) direction 430. Accordingly, a gain of the dielectric resonator antenna 100 at 77 GHz is 7.1 dBi, and the dielectric resonator antenna 100 has a similar high-gain characteristic to that of the dielectric resonator antenna 200 of FIG. 4.

Accordingly, it can be seen that the dielectric resonator antenna suggested in the present invention and the antenna structure, in which the metal pattern is exposed, are little different in performance.

In the dielectric resonator antenna of the present invention, the surrounding area of the dielectric resonator is implemented in a form, such as a metal wall (the vias, the metal pattern, and the internal ground surface) preventing a leakage of the signal. In this case, only a part of the dielectric resonator at the topmost portion of the multilayer substrate may be opened as the opened surface, thereby transmitting a signal.

As described above, the dielectric resonator antenna of the present invention uses the buried dielectric resonator, so that the dielectric resonator antenna may be manufactured even without using a expensive gold plating process for protecting (for example, preventing oxidation) the metal pattern exposed to the outside of the substrate. Accordingly, process cost of the dielectric resonator antenna suggested in the present invention is decreased, and broadband high-gain performance thereof is not decreased.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A dielectric resonator antenna, comprising:
a dielectric resonator;
an antenna layer which the dielectric resonator formed inside including a plurality of vias positioned at a surrounding area of the dielectric resonator;
a metal pattern forming an opened surface in an upper portion of the antenna layer;
a dielectric layer configured to cover the metal pattern on the dielectric resonator;
an internal ground pattern including a coupling aperture for inputting a signal into the dielectric resonator under the dielectric resonator; and
a feeding layer including a strip transmission line for transmitting a signal to the dielectric resonator, and positioned under the antenna layer.

2. The dielectric resonator antenna of claim 1, further comprising:
an external ground surface positioned under the feeding layer.

3. The dielectric resonator antenna of claim 1, wherein the plurality of vias is formed inside the antenna layer, and forms a metallic fence of the dielectric resonator so as to suppress leakage of a signal.

4. The dielectric resonator antenna of claim 1, wherein the plurality of vias is disposed by setting an interval between the plurality of vias to have a value corresponding to ¼ of a frequency wavelength of the dielectric resonator antenna.

5. The dielectric resonator antenna of claim 1, wherein a bandwidth of the dielectric resonator antenna is expanded by adjusting a size of a coupling aperture.

6. The dielectric resonator antenna of claim 1, wherein the dielectric resonator and the metal pattern are buried inside the antenna layer, the dielectric layer, and the feeding layer.

7. The dielectric resonator antenna of claim 1, wherein the feeding layer includes a plurality of vias positioned at a surrounding area of the strip transmission line.

8. The dielectric resonator antenna of claim 7, wherein the feeding layer includes two layers, and
the strip transmission line is positioned between the two layers.

9. The dielectric resonator antenna of claim 8, wherein the internal ground pattern and the external ground surface are connected through the plurality of vias positioned at a surrounding area of the strip transmission line.

10. A dielectric resonator antenna, comprising:
a plurality of layers;
a dielectric resonator positioned inside the plurality of layers;
a plurality of vias positioned inside the plurality of layers, and positioned at a surrounding area of the dielectric resonator antenna;
a metal pattern positioned on the dielectric resonator, and buried inside the plurality of layers; and
an internal ground pattern positioned under the dielectric resonator, and positioned between the plurality of layers,
wherein the metal pattern and the internal ground surface are connected with each other through the plurality of vias.

11. The dielectric resonator antenna of claim 10, wherein the plurality of vias forms a metallic fence of the dielectric resonator so as to suppress leakage of a signal.

12. The dielectric resonator antenna of claim 10, wherein the plurality of vias is disposed by setting an interval between the plurality of vias to have a value corresponding to ¼ of a frequency wavelength of the dielectric resonator antenna.

13. The dielectric resonator antenna of claim 10, wherein the internal ground pattern includes a coupling aperture for inputting a signal into the dielectric resonator, and
a bandwidth of the dielectric resonator antenna is expanded by adjusting a size of the coupling aperture.

14. The dielectric resonator antenna of claim 13, wherein the plurality of layers include:
an antenna layer on which the dielectric resonator and the plurality of vias are formed;
a dielectric layer positioned on the antenna layer; and
a feeding layer positioned under the antenna layer to transmit a signal to the dielectric resonator.

15. The dielectric resonator antenna of claim 14, further comprising:
an external ground surface positioned under the feeding layer.

16. The dielectric resonator antenna of claim 15, wherein the feeding layer includes:
a strip transmission line configured to transmit a signal to the dielectric resonator; and
a plurality of vias positioned at a surrounding area of the strip transmission line, and
the plurality of vias connects the internal ground pattern and the external ground surface.
